(19) United States
(12) Patent Application Publication
(10) Pub. No.: US 2005/0201536 A1
(43) Pub. Date: Sep. 15, 2005

(54) Control of desired marketing electronic mail through use of anonymous recipients and public key infrastructure (PKI)

(75) Inventors: Robert Clarence LaLonde, Augusta, GA (US); Stephen Anthony Lee, Callahan, FL (US)

Correspondence Address: ROBERT C. LALONDE, 3118 EXETER ROAD, AUGUSTA, GA, 30909, US

(73) Assignees: Robert Clarance LaLonde, Augusta, GA (US); Stephen Anthony Lee, Callahan, FL (US)

(21) Appl. No.: 10/708,969

(22) Filed: Apr. 4, 2004

Related U.S. Application Data
(63) Continuation of application No. 10/708,514, filed on Mar. 9, 2004.
(63) Continuation of application No. 10/708,968, filed on Apr. 4, 2004.

(51) Int. Cl. H04M 11/00

(52) U.S. Cl. 379/93.24

(57) ABSTRACT

An enhanced email system that will allow for marketing to anonymous consumers, protecting their privacy and reducing unwanted marketing. Consumers register interest in products and services as well as enough information to ensure delivery of communications and prevent abuse. Consumers have the ability to terminate communication at any time as well as the option to communicate directly. Merchants have the ability communicate confidentially with groups of consumers or individual ones. Categorization of wanted versus unwanted by use of sender identification. The system will be monitored for abuse and actions will be taken to prevent abuse.

### CROSS REFERENCE To RELATED APPLICATIONS

This application depends upon the patent application Ser. No. 10/708,514, filed on Mar. 9, 2004 at 13:59:39 EDT, titled “Reduction in unwanted e-mail (spam) through the use of portable unique utilization of public key infrastructure (PKI)”. Specifically, the “Use of unique keys maintained by third party to end users for classification of email” in Ser. No. 10/708,514 allows or proper identification of senders, facilitating the future willingness of a consumer to voluntarily break their anonymity The “System of email forwards to support universal portability” in Ser. No. 10/708,514 is not incompatible with “Method for providing consumer anonymity via secure e-mail forwarding” in this application. They may e unified for users of both systems. It is assumed that “Specific email server and client plug-ins to be developed to support portability” in Ser. No. 10/708,514 may the same as the those that provide the functionality for this invention. This application also depends upon patent application Ser. No. 10/708,968 filed on Apr. 4, 2004 at 15:28:52 EDT. Specifically, “Methods for delivery and maintenance of group PKI” in Ser. No. 10/708,968 allows for “Method for support of confidential encrypted marketing” in this application

### SUMMARY OF INVENTION

The primary weakness of email is its indiscriminate nature. This is especially true in marketing. Most marketing by electronic mail is not targeted. In many cases the recipient is not interested. Unfortunately, due to the amount of unwanted email, even targeted email may be ignored

Users may hesitate to provide email addresses to companies for fear of misuse. It is not uncommon to find removal from a mailing list difficult, even if it was voluntary to begin with.

This method allows for voluntary participation of consumers in marketing email. If an end user is interested in a product or service and would like to be contacted, then it is possible to register for it. A forwarding rule will be created and a temporary email address provided to merchants that specialize in the area of interest.

If the consumer replies to an advertisement, then true email addresses can be exchanged if desired. When the consumer removes their interest, or when it expires, the forwarding rule is deleted with the temporary email address.

The consumer then has a freedom that only the merchants have had in the past; anonymity and privacy.

If all email users are uniquely identified by PKI, then this method can be enhanced with unique identification of the merchants, allowing enforcement of privacy rules. Misuse by a merchant can then be detected or reported. This also increases the likelihood that consumers will feel free to provide their real email address to the merchant allowing the relationship to last past the temporary forwarding address.

### DETAILED DESCRIPTION

A secure server will be setup to allow for consumers to register interest in products or services The server will maintain the privacy of the consumers.

A temporary email address will be created for the consumer with automatic forwarding to their personal address. This temporary email address will be provided to the merchants that provide the products and services that the consumer is interested in.

The consumer has the option of utilizing the temporary address for replies to the merchants, if concerned about continuing privacy.

Communication with the merchant can be terminated when the temporary address expires or when the consumer terminates the forwarding.

To prevent against abuse by consumers to send anonymous email, they may only be allowed to send to merchants that provide the products or services on the consumers list of interests and consumers may be required to provide proof of identity.

This marketing system can trust unique email email identities provided by patent application for “Reduction in unwanted e-mail (spam) through the use of portable unique utilization of public key infrastructure (PKI)”.

If enhanced by “Reduction in unwanted e-mail (spam) through the use of portable unique utilization of public key infrastructure (PKI)” then unique identification of the merchants, allows enforcement of privacy rules. Misuse by a merchant can then be detected or reported.

If enhanced by “Reduction in unwanted e-mail (spam) through the use of portable unique utilization of public key infrastructure (PKI)” then consumers are more likely to breach their own anonymity and form longer term communications with participating merchants.

If enhanced by the group encryption email method in the patent application “Classification of wanted e-mail via web of relationship utilization of Public Key Infrastructure (PKI)”, then the merchants have the ability send encrypted marketing. This provides for the ability to send private and confidential offers to a group or an individual which would be a group of one.

This invention neither requires nor precludes other methods of controlling unwanted email.

1. Method for providing consumer anonymity via secure e-mail forwarding.

2. Specific email server, web applications, and client plug-ins to be developed to support anonymous consumers.

3. Method for support of confidential encrypted marketing.
